(19) United States
(12) Patent Application Publication
(10) Pub. No.: US 2004/0183710 A1
(43) Pub. Date: Sep. 23, 2004

(54) Combination horologe and RF transmitter

(76) Inventors: Ryan Else, Rocklin, CA (US); Kyle Else, Atherton, CA (US); Phillip Edward Straw, El Granada, CA (US)

Correspondence Address: Anthony T. Cascio, Suite 314, 423 Broadway Ave., Millbrae, CA, 94030, US

(21) Appl. No.: 10/390,527

(22) Filed: Mar. 17, 2003

(51) Int. Cl. H04L 17/02; G08C 19/12

(52) U.S. Cl. 341/176; 340/825.69; 340/825.72

(57) ABSTRACT

A personal device normally carried on or about a user is combined with an RF transmission circuit. The device includes a case and at least one function button carried by the case. The RF transmission circuit is disposed within the case and includes a processor, a memory and an RF transmitter. The memory has at least one digital code stored therein. The processor is responsive to actuation of the function button to apply the code to the transmitter. The transmitter is further responsive to actuation of the function button to transmit a carrier signal modulated by the code applied thereto. The code when received by a corresponding receiver may then develop a control signal. The control signal may then be used to activate circuitry in a device to be controlled. Alternatively, the transmitter may periodically transmit an address. The device to be controlled may then include a receiver responsive to this address. When the personal device is proximal to the device to be controlled, its receiver then develops the control signal without any other user intervention.

### BACKGROUND OF THE INVENTION

The present invention relates generally to a combination of a horologe and a RF transmitter circuit, and, more particularly, to such combination wherein the transmitter circuit transmits information to be received at a remote device to be controlled.

Remote keyless entry systems of various types are known in the art and commercially available. For example, a remote keyless entry system for a motor vehicle typically includes a key fob having a plurality of function buttons thereon. Each one of the function buttons is associated with a respective one of desired functions or activities to be performed or occur at the motor vehicle. Typically, the buttons on the fob may include iconic representations thereon to indicate the function to be performed, such as lock and unlock doors, unlock trunk, and sound alarm. Upon pressing one of the function buttons, the desired action is taken at the motor vehicle.

More particularly, the key fob includes a transmitter circuit board having at least a processor, a memory and a transmitter. The memory digitally stores a plurality of codes, wherein each of the codes is associated with a respective one of the function buttons. Upon pressing one of the function buttons, the processor reads which of the buttons has been pressed, and retrieves the associated code from memory. The processor applies the retrieved code to the transmitter that, in turn, modulates the code onto a RF carrier for transmission.

An associated receiver, mounted in the device to be controlled, includes a receiver, a processor and a plurality of output interfaces. The receiver detects the modulated RF carrier and demodulates it to retrieve the transmitted code. The processor then reads the code and develops a signal at one of the output interfaces associated with the received code. The signal developed at the output interface then activates the device to be controlled. For example, the device to be controlled may be a door lock actuator of the motor vehicle.

A disadvantage and limitation of the prior art key fob transmitter apparatus is that such apparatus is generally bulky when carried on a key ring with the keys to the motor vehicle and all other keys, which the user may need. Accordingly, many users do not always carry a key ring with such key fob attached on their person when use of the fob is not needed. For example, a user may have traveled to a distant destination by air leaving a motor vehicle at the departing airport. Upon arriving at a hotel at the destination, the user may then secure the unneeded key ring with the fob attached in the user's luggage to obviate the possibility of unintended loss. However, when the user returns to the departing airport and attempts to gain access to the motor vehicle, the user may have forgotten to first retrieve the key ring with the fob from the luggage, thereby initiating a potentially awkward search through the luggage for the key ring in a parking lot.

However, many users, as normal habit and routine, wear a horologe on a daily basis, or carry with them other devices such as PDA, notebook computers, cellular telephones and the like. Horologes, such as a conventional wristwatch, and each of these other devices, already contain a plurality of buttons selectable by the user. However, packaging efficiencies of horologes and other user devices minimize unused space within their packaging, such that the typical transmitter circuit board used in the key fob is generally larger than the available free space within these devices. Accordingly, there is not known any teaching in the prior art that would suggest a combination of a horologe or other personal device with a remote keyless entry system.

There have, however, been some prior art attempts to add functionality, not relating to timekeeping, to a horologe such as a wristwatch. In Narayanaswami, et al., U.S. Pat. No. 6,477,117, an alarm interface with a smart watch is disclosed. Particularly, the Narayanaswami reference states that there have been attempts to incorporate some of the capabilities of PDA's, cellular telephones, pagers and other similar devices into wrist watches, but that such attempts have only resulted in specialty wearable watch devices that, besides time keeping functions, may possess a compass, a Global Positioning System (GPS), or barometer, heart rate monitor, Personal Handy System (PHS) phone or pager. A disadvantage and limitation of these devices is, as set forth in the Narayanaswami reference, that most of them are bulky, are mostly unconnected to the Internet or other PC/network devices, have limited battery life, and, are difficult to use.

The Narayanaswami reference in particular discloses a wristwatch that includes alarm functions accessible through a simplified user interface and the ability to transmit and receive alarm setting from other identical devices. Although the device as disclosed in the Narayanaswami reference attempts to overcome the disadvantages and limitations of the prior art mentioned therein, such solution results only in a device that, although it possesses communication capabilities, can only communicate with like devices for setting of alarm functions. Accordingly, the Narayanaswami reference in its entirety teaches away from the combination of horologe with remote keyless entry functions.

Passive entry and start systems for motor vehicles are also known, for example of the type disclosed in Banas, U.S. Pat. No. 6,396,412. In a passive entry and start system, an ID device is carried by the user. Bi-directional RF communications are established between the ID device and a corresponding controller on the vehicle when the ID device brought into relative proximity to the vehicle. Once communications have been authenticated and established, the user need only to touch a control surface to initiate a desired action. For example, a door handle of a normally locked vehicle door may have tactile or capacitive sensors to detect the touching of a door handle when entry is desired into the vehicle. If communication has been established and authenticated between the ID device and the vehicle controller, the controller will activate the lock/unlock circuitry of the vehicle to unlock the door upon such touching being detected to allow entry.

Similarly to the disadvantages and limitations of remote keyless entry system, the passive entry and start system requires that the user carry the ID device at all times,

Typically, the horologe 10 may have further buttons 14₂₋ₙ also carried by the case. In such case the memory 20 stores a plurality of codes, wherein each of the codes is associated with one of the buttons 14₁₋ₙ. User activation of any of the buttons 14₁₋ₙ causes the processor 18 to retrieve the associated code from the memory 20, which as described above, is applied to the transmitter 22 for modulation and broadcast from the antenna 24. For example, the processor 18 may repeatedly read the state of each of the buttons 14₁₋ₙ as an n-length binary word wherein the state of each of the buttons 141₁₋ₙ is a respective bit in such word. Upon one of the buttons 14₁₋ₙ being activated by the user, the bit position for such button 14ₓ changes state. After the processor reads the n-length word, it may then use such word to develop an address at which the code for the activated one of the buttons 14₁₋ₙ is stored.

In order to execute remote functions from the horologe 10, a receiver circuit board 26 is disposed at the device 28 to be controlled, as best seen in FIG. 3. The receiver circuit board 26 includes a receiver 30, a receiver processor 32 and at least one output interface 34₁. The modulated RF carrier is detected by a receiver antenna 36 to apply the RF carrier as an electrical signal to the receiver 30. The receiver 30 demodulates the carrier to obtain the transmitted code, which is then read by the receiver processor 32. If the receiver processor 32 recognizes the received code, the receiver processor 32 develops a control signal at the output interface 34₁.

As described above, a possibility exists that several codes may be transmitted for recognition by the processor 32. Accordingly, the receiver circuit board 26 may further include a receiver memory 38 which electronically stores all codes to be recognized, such as in a look-up table. Furthermore, each one of the output interfaces 34₁₋ₙ is associated with one of the codes in the receiver memory 38. Upon a received code matching one of the codes stored in the receiver memory 38, the processor 32 will develop a control signal at the associated one of the output interfaces 34₁₋ₙ.

Generally, the code broadcast by the transmitter 22 is preceded by a header, as is well known. The header contains an address, which is associated with the receiver. which may be relatively bulky due to the active circuits and battery power needed. Although such device may take the form of another fob or be built into the vehicle key, again the user may not always desire to carry such fob or key.

### SUMMARY OF THE INVENTION

Accordingly, it is an object of the present invention to overcome one or more disadvantages and limitations of the prior art. Another object of the present invention is to provide a horologe, or other personal device, with a RF transmitter such that selected codes may be transmitted and received by an associated receiver to command a remote device.

According to the present invention, a personal device normally carried on or about a user is combined with an RF transmission circuit. The device includes a case and at least one function button carried by the case. The RF transmission circuit is disposed within the case and includes a processor, a memory and an RF transmitter. The memory has at least one digital code stored therein. The processor is responsive to actuation of the function button to apply the code to the transmitter. The transmitter is further responsive to actuation of the function button to transmit a carrier signal modulated by the code applied thereto. A corresponding receiver circuit develops a control signal to control a remote device in the event the code is recognized at the receiver circuit.

In another embodiment of the present invention, the personal device may be combined with an RF transmission system, wherein the RF transmission system includes a transmitter circuit and a receiver circuit. The transmitter circuit is disposed within the case and periodically transmits a carrier signal modulated by an address. The receiver circuit is disposed at the device to be controlled and is responsive to the address when the personal device is proximal to the device to be controlled to develop a control signal. The device to be controlled has further circuitry that is enabled upon application of the control signal thereto.

A feature of the present invention is that the transmitter circuit, normally carried in a fob, is integrated with a personal device normally carried on or about the user. This feature advantageously obviates the need to carry an extra key fob, as is required in the prior art.

These and other objects, advantages and features of the present invention will become readily apparent to those skilled in the art from a study of the following Description of the Exemplary Preferred Embodiments when read in conjunction with the attached Drawing and appended Claims.

### BRIEF DESCRIPTION OF THE DRAWING

FIG. 1 is a cutaway view of a horologe incorporating an RF transmitter therein.

FIG. 2 is a cross-sectional view of the horologe of FIG. 1.

FIG. 3 illustrates a transmission system useful with the horologe of FIG. 1.

### DESCRIPTION OF THE EXEMPLARY PREFERRED EMBODIMENTS

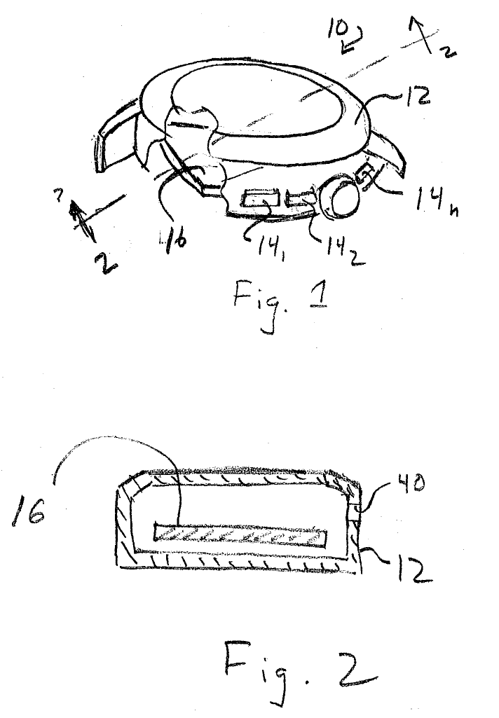

Referring now to FIGS. 1-2, there is shown a horologe 10 having a case 12 and at least one user selectable function button 14₁ carried by the case. Within the case 12 is disposed a transmitter circuit board 16.

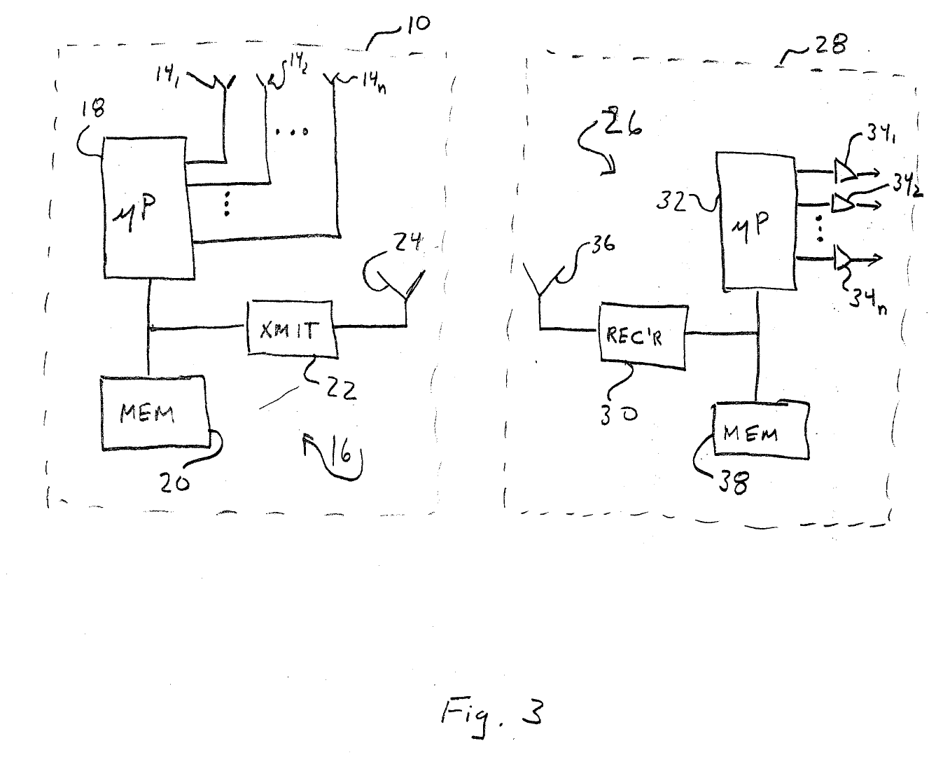

With further reference to FIG. 3, the transmitter circuit board 16 includes a transmitter processor 18, a transmitter memory 20 and a transmitter 22. User activation of the button 14₁ signals the processor 18 to retrieve a digitally stored code from the memory 20 and apply such code to the transmitter 22. The transmitter 22 in turn modulates the code onto a RF carrier and the modulated carrier is transmitted from an antenna 24. When the receiver demodulates the RF carrier, retrieving the code and address, the receiver processor may also read the address such that only codes intended for the receiver circuit board are read if it recognizes the proper address, and all other received transmissions are ignored.

In another embodiment of the present invention, the transmitter in the horologe 10 may periodically broadcast a message containing only the header address information intended for the receiver. As a user with the horologe 10 approaches the device 28 to be controlled, the receiver begins to receive the RF carrier. If the address is recognized, the receiver processor may then develop a control signal at the output interface 34₁. In this embodiment only one such output interface is needed. The device 28 to be controlled may then contain additional circuitry responsive to the control signal.

For example, such additional circuitry may be tactile sensing circuitry that is powered on upon sensing the control signal. The user upon touching an item containing the tactile sensing circuitry at the device 28 to be controlled by the tactile sensing circuitry then develops a further control signal that may cause the device 28 to function. Such additional circuitry is commercially available, such as the passive auto start and entry system provided by Siemens VDO. Alternatively, an RF-RF system, similar to such system, as disclosed in the aforementioned U.S. Pat. No. 6,396,412 and incorporated herein by reference, may also be used to practice the present invention wherein the ID device is combined with the horologe 10 as hereinabove described.

In one embodiment of the present invention, the horologe 10 may be a conventional or mechanical wristwatch. Should the case of such conventional or mechanical wristwatch be made of metal, which acts as a barrier to RF signals, the antenna 24 may be mounted external of the case. In such embodiment, the antenna 24 may be disposed through a small orifice 40 in the case and extended through the wristband. However, should the wristwatch have sufficient nonmetallic surfaces or gaps through which RF signals may pass, the antenna 24 may be disposed completely within the case 12.

It is also contemplated by the present invention that the horologe 10 may be an electronic watch in which the watch movement circuits and the transmitter circuit are integrated onto a single circuit card. It is also contemplated that the watch movement circuits and the transmitter circuit are integrated as a single chip.

Although the preferred exemplary embodiment of the present invention has been described in conjunction with a horologe, the present invention may be practiced with any device wearable or normally carried by the user. For example, a PDA, notebook computer or the like may be equipped with either one of the transmitter circuits as described above. A typical transmitter circuit board 16 suitable for use in the horologe 10 is a commercially available code hopping encoder, model HCS362 from Microchip Technology Incorporated under the KeeLoq® trademark.

There has been described hereinabove a novel horologe with RF transmitter. Those skilled in the art may now make numerous uses of, and departures from, the above described preferred embodiments without departing from the inventive concepts and principals disclosed herein. Accordingly, the present invention is to be defined solely by the lawfully permitted scope of the following Claims.

What is claimed as the invention is:

1. A combination comprising a personal device normally carried on or about a user and an RF transmission circuit, said device including a case and at least one function button carried by said case, said RF transmission circuit being disposed within said case and including a processor, a memory and an RF transmitter, said memory having at least one digital code stored therein, said processor being responsive to actuation of said function button to apply said code to said transmitter, said transmitter being further responsive to actuation of said function button to transmit a carrier signal modulated by said code applied thereto, said code being intended for use at a device to be controlled.

2. A combination as set forth in claim 1 wherein said device includes at least one further function button carried by said case and said memory having at least one further digital code stored therein, said processor and said transmitter being further responsive to actuation of said further button to transmit said further code.

3. A combination as set forth in claim 1 wherein said transmitter contains an antenna, said case including an aperture through which said antenna is dispose such that a portion of said antenna is external of said case.

4. A combination as set forth in claim 3 wherein said device is a horologe having a wristband, said portion of said antenna external of said case being carried by said wristband.

5. A combination as set forth in claim 1 further comprising an RF receiver circuit adapted to be disposed at said device to be controlled, said RF receiver circuit including a processor, a receiver and an output interface, said receiver being responsive to receipt of said carrier signal to apply said code to said processor, said processor being responsive to said code to develop a control signal at said output interface, said output interface being adapted to apply said control signal to said device to be controlled.

6. A combination as set forth in claim 5 wherein said code is preceded by a header having address information, said processor being responsive to said code only in the event said address information addresses said receiver circuit.

7. A combination as set forth in claim 1 wherein said device normally carried on or about a user is a horologe.

8. A combination as set forth in claim 1 wherein said device normally carried on or about a user is a PDA.

9. A combination as set forth in claim 1 wherein said device normally carried on or about a user is a notebook computer.

10. A combination as set forth in claim 1 wherein said device normally carried on or about a user is a mobile telephone.

11. A combination comprising a device normally carried on or about a user and an RF transmission system, said device including a case, said RF transmission system including a transmitter circuit and a receiver circuit, said transmitter circuit disposed within said case and periodically transmitting a carrier signal modulated by an address, said receiver circuit being disposed at a device to be controlled and being responsive to said address when said personal device is proximal said device to be controlled to develop a control signal, said device to be controlled having further circuitry which is enabled upon application of said control signal thereto.

12. A combination as set forth in claim 11 wherein said transmitter contains an antenna, said case including an aperture through which said antenna is dispose such that a portion of said antenna is external of said case.

13. A combination as set forth in claim 12 wherein said device is a horologe having a wristband, said portion of said antenna external of said case being carried by said wristband.

14. A combination as set forth in claim 11 wherein said receiver circuit includes a processor, a receiver and an output interface, said receiver being responsive to receipt of said carrier signal to apply said address to said processor, said processor being responsive to said address to develop said control signal at said output interface, said output interface being adapted to apply said control signal to said further circuitry.

15. A combination as set forth in claim 14 wherein said processor is responsive to said address only in the event said address addresses said receiver circuit.

16. A combination as set forth in claim 11 wherein said device normally carried on or about a user is a horologe.

17. A combination as set forth in claim 11 wherein said device normally carried on or about a user is a PDA.

18. A combination as set forth in claim 11 wherein said device normally carried on or about a user is a notebook computer.

19. A combination as set forth in claim 11 wherein said device normally carried on or about a user is a mobile telephone.

20. A combination comprising a device normally worn by a user and a selected one of an RF-RF and LF-RF transmission system, said transmission system including a first receiver/transmitter pair disposed within said device and a second receiver/transmitter pair disposed at a device to be controlled, said first receiver/transmitter pair and second receiver/transmitter pair establishing communications therebetween when in relative proximity to each other to determine validity of said first receiver/transmitter pair, said device to be controlled having further circuitry which is enabled upon sensing of said user imminently engaging a control surface of said device to be controlled in the event said first receiver/transmitter pair is valid.

21. A combination as set forth in claim 20 wherein said device normally worn by a user is an horologe.

22. A combination as set forth in claim 20 wherein said device normally carried on or about a user is a PDA.

23. A combination as set forth in claim 20 wherein said device normally carried on or about a user is a notebook computer.

24. A combination as set forth in claim 20 wherein said device normally carried on or about a user is a mobile telephone.
